(19) United States
(12) Patent Application Publication
(10) Pub. No.: US 2010/0254348 A1
(43) Pub. Date: Oct. 7, 2010

(54) METHOD AND APPARATUS TO ENABLE MULTIPLE NEIGHBOUR ACCESS POINTS PREPARATION FOR HANDOVER ROBUSTNESS

(75) Inventors: Rajat Prakash, San Diego, CA (US); Parag Arun Agashe, San Diego, CA (US); Fatih Ulupinar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/751,776

(22) Filed: Mar. 31, 2010

Related U.S. Application Data
(60) Provisional application No. 61/165,842, filed on Apr. 1, 2009.

(51) Int. Cl. H04W 36/00

(52) U.S. Cl. 370/331

(57) ABSTRACT

Systems and methods are disclosed to enable multiple neighbour base stations or access points (APs) preparation for handover robustness. The systems and methods include generating a handover request message at a source base station (BS) for user equipment (UE) if the UE detects at least one neighbour BS. The handover request message may include a handover imminent flag. The handover request message is transmitted to the neighbour BS, wherein if the handover imminent flag indicates that the handover is not imminent, the neighbour BS does not reserve a radio network temporary identifier (RNTI) for the UE.

### CROSS-REFERENCE TO RELATED APPLICATIONS

This application claims the benefit pursuant to 35 U.S.C. 119(e) of U.S. Provisional Application No. 61/165,842, filed Apr. 1, 2009, which application is specifically incorporated herein, in its entirety, by reference.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

In addition to mobile phone networks currently in place, a new class of small base stations has emerged, which may be installed in a user's home and provide indoor wireless coverage to mobile units using existing broadband Internet connections. Such personal miniature base stations are generally known as access point base stations, or, alternatively, Home Node B (HNB) or femto cells. Typically, such miniature base stations are connected to the Internet and the mobile operator's network via DSL router or cable modem.

In mobile communication systems, handover is a process in which a serving cell or sector for user equipment (UE), e.g., a mobile device, is changed. Handover may be initiated when the signal strength of another cell is stronger than the current cell. Unfortunately, due to rapidly changing signal strength from the serving cell, the handover signaling may be lost.

One known method to increase the robustness of handover is to prepare multiple cells for handover, while the serving cell signal remains strong. By such preparation, even if the signaling message at the time of handover is lost, the UE is able to re-establish the connection through the prepared cell.

Unfortunately, preparing the cell for handover may involve reserving a radio network temporary identifier (RNTI) at the access point (AP) for the cell, which results in a relatively large associated cost with the network elements of the AP, such as the transceivers. When multiple access points (APs) are prepared in advance for a UE, each AP has to assign a RNTI to the UE, leading to an increase in the average number of RNTIs reserved per UE in the system. Due to these costs, the network may find it difficult to prepare the number of cells that are required for robust handover.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 is a block diagram of a communication system;

FIG. 3 illustrates a multiple access wireless communication system;

FIG. 4 illustrates an exemplary communication system to enable deployment of access point base stations within a network environment;

FIG. 5A illustrates a methodology for a wireless communication system in which the source AP generates handover request messages;

FIG. 5B illustrates another scenario in which a radio link failure (RLF) event occurs;

FIG. 6 is a block diagram showing a handover request message with a handover probability value;

FIG. 7 is an example of a methodology for transmitting a handover cancel message to a neighbour AP;

FIG. 8 is an example of a methodology for UE context change or loss of synchronization;

FIG. 9 is a flowchart that illustrates functions performed by the source AP to enable handover robustness to neighbour APs; and

FIG. 10 is a flowchart that illustrates functions performed by the neighbour AP to enable handover robustness.

### DESCRIPTION

Systems and methods are provided to enable multiple neighbour access points (APs) preparation for handover robustness. The systems and methods include generating a handover request message at a source access point (AP) for user equipment (UE) if the UE detects at least one neighbour AP. The handover request message may include a handover imminent flag. The handover request message is transmitted to the neighbour AP, wherein if the handover imminent flag indicates that the handover is not imminent, the neighbour AP does not reserve a radio network temporary identifier (RNTI) for the UE. The neighbour AP may store received UE context information. However, when a handover does become imminent, a handover request message is transmitted to the neighbour AP, wherein the handover imminent flag indicates that handover is imminent, and the neighbour AP reserves a radio network temporary identifier (RNTI) for the UE and may utilize the previously stored UE context information.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

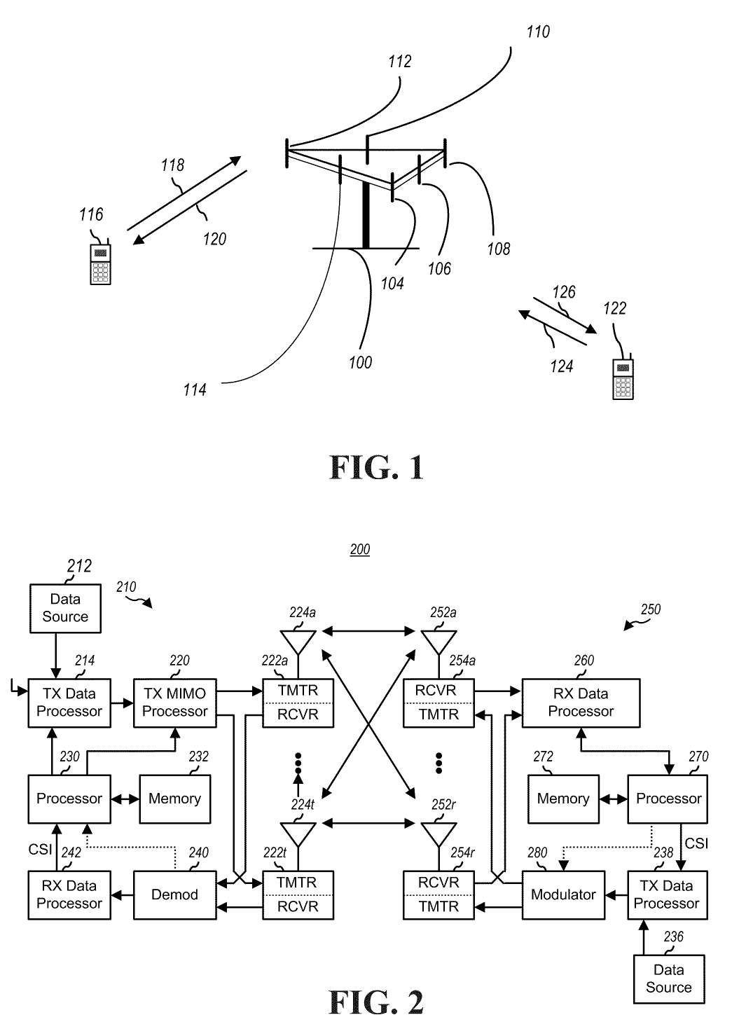

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighbouring cells than an access point transmitting through a single antenna to all its access terminals.

An access point (AP) may be a fixed station used for communicating with the terminals and may also be referred to as a base station, a Node B, an evolved Node B (eNB), or some other terminology. An access terminal may also be called a mobile station, user equipment (UE), a wireless communication device, a mobile device, a terminal, or some other terminology.

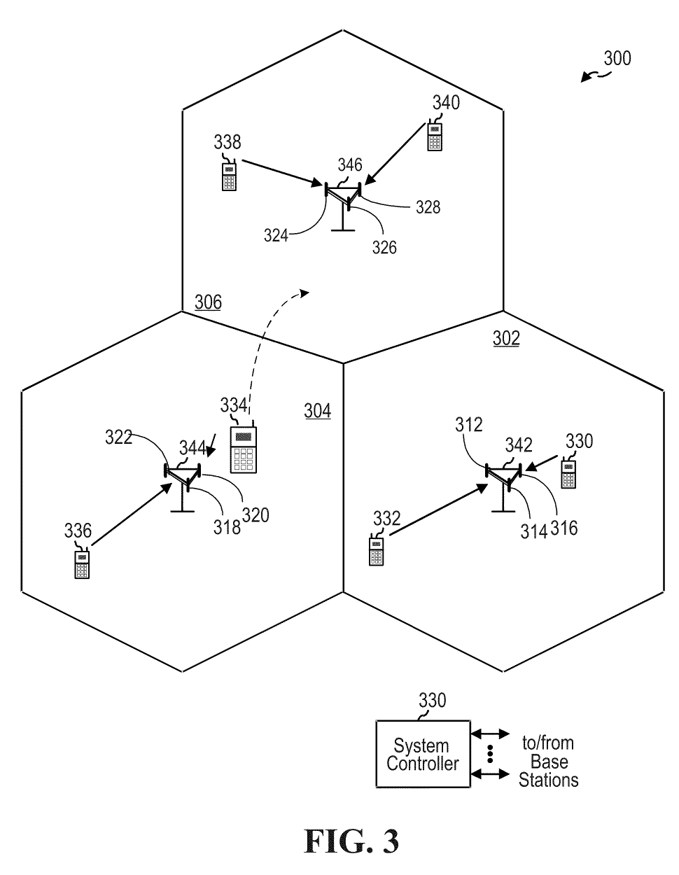

FIG. 2 is a block diagram of an embodiment of a transmitter system 210 (also known as the access point (AP)) and a receiver system 250 (also known as access terminal, a mobile device, or user equipment (UE)) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., binary phase-shift keying (BPSK), quadrature phase-shift keying (QPSK), m-ary phase-shift keying (M-PSK), or m-ary quadrature amplitude modulation (M-QAM)) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprises a set of DL channels and UL channels. The DL PHY channels comprises: a Common Pilot Channel (CPICH), a Synchronization Channel (SCH), a Common Control Channel (CCCH), a Shared DL Control Channel (SDCCH), a Multicast Control Channel (MCCH), a Shared UL Assignment Channel (SUACH), a Acknowledgement Channel (ACKCH), a DL Physical Shared Data Channel (DL-PSDCH), a UL Power Control Channel (UPCCH), a Paging Indicator Channel (PICH), and a Load Indicator Channel (LICH). The UL PHY Channels comprises: a Physical Random Access Channel (PRACH), a Channel Quality Indicator Channel (CQICH), a Acknowledgement Channel (ACKCH), a Antenna Subset Indicator Channel (ASICH), a Shared Request Channel (SREQCH), a UL Physical Shared Data Channel (UL-PSDCH), and a Broadband Pilot Channel (BPICH).

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

AP Access Point

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCHMBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCHPhysical Channels

QoS Quality of Service

RACH Random Access CHannel

RLC Radio Link Control

RLF Radio Link Failure

RNTI Radio Network Temporary Identifier

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

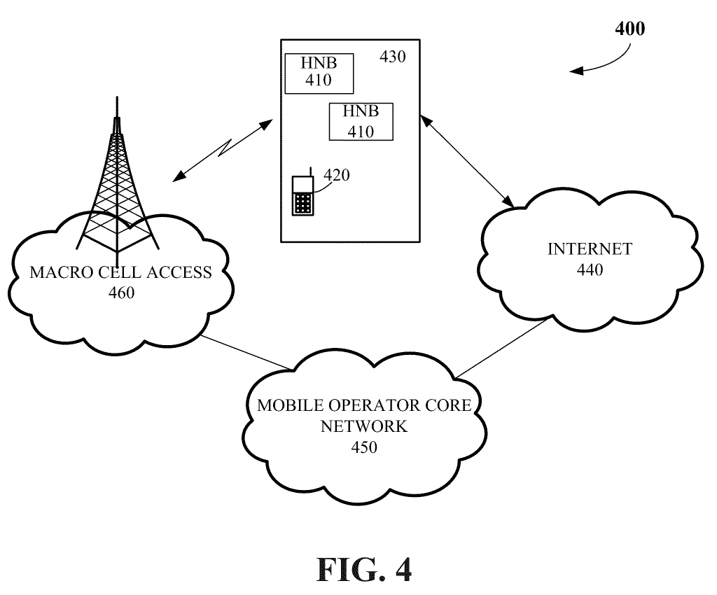

Referring to FIG. 3, a multiple access wireless communication system 300 is illustrated. The multiple access wireless communication system 300 includes multiple cells, including cells 302, 304, and 306. In the aspect the system 300, the cells 302, 304, and 306 may include a Node B, evolved Node B (eNB), or access point (AP) [referred to interchangeably] that includes multiple sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 can include several wireless communication devices, e.g., user equipment or UEs, which can be in communication with one or more sectors of each cell 302, 304 or 306. For example, UEs 330 and 332 can be in communication with Node B 342, UEs 334 and 336 can be in communication with Node B 344, and UEs 338 and 340 can be in communication with Node B 346.

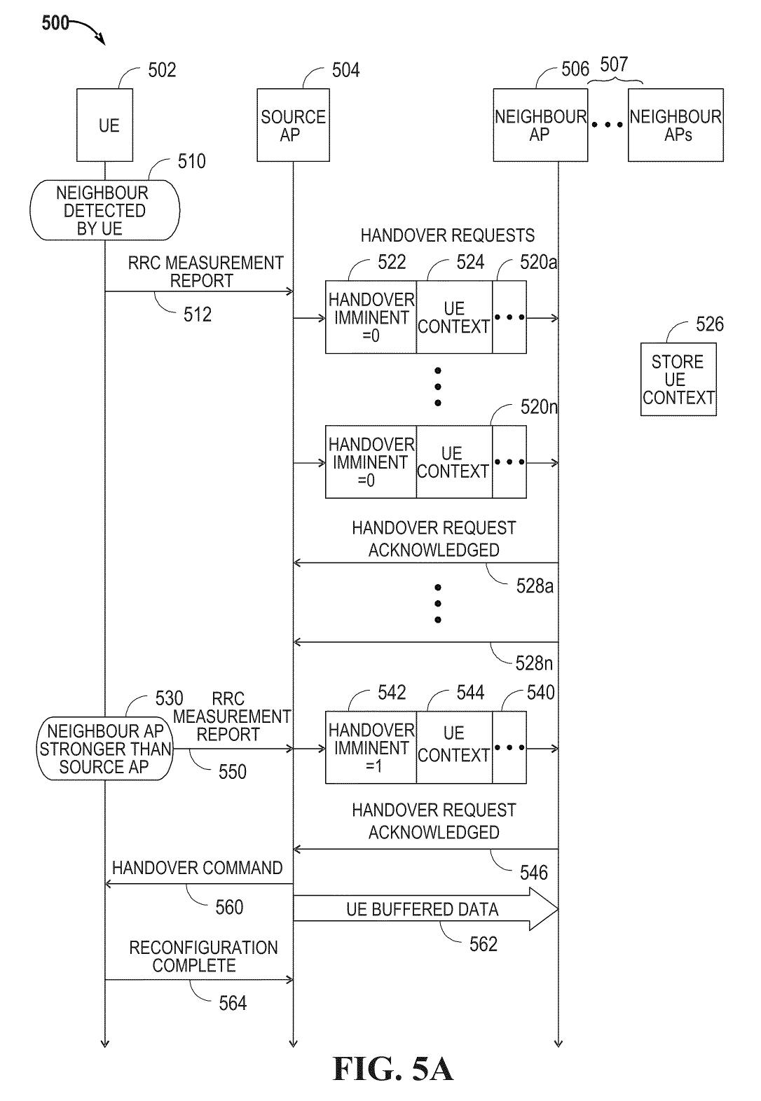

FIG. 4 illustrates an exemplary communication system to enable deployment of access point base stations within a network environment. As shown in FIG. 4, the system 400 includes multiple access point base stations or, in the alternative, femto cells, Home Node B units (HNBs), or Home evolved Node B units (HeNBs), such as, for example, HNBs 410, each being installed in a corresponding small scale network environment, such as, for example, in one or more user residences 430, and being configured to serve associated, as well as alien, user equipment (UE) or mobile stations 420. Each HNB 410 is further coupled to the Internet 440 and a mobile operator core network 450 via a DSL router (not shown) or, alternatively, a cable modem (not shown), and macro cell access 460.

Systems and methods are provided to enable multiple neighbour access points (APs) preparation for handover robustness. The systems and methods include generating a handover request message at a source access point (AP) for user equipment (UE) if the UE detects at least one neighbour AP. The handover request message may include a handover imminent flag. The handover request message is transmitted to the neighbour AP, wherein if the handover imminent flag indicates that the handover is not imminent, the neighbour AP does not reserve a radio network temporary identifier (RNTI) for the UE. The neighbour AP may store received UE context information. However, when a handover does become imminent, a handover request message is transmitted to the neighbour AP, wherein the handover imminent flag indicates that handover is imminent, and the neighbour AP reserves a radio network temporary identifier (RNTI) for the UE and may utilize the previously stored UE context information.

As previously described in FIG. 2, both AP 210 and UE 250 include processors that execute instructions and memories that retain instructions to enable identification and wireless communication between various UEs and APs.

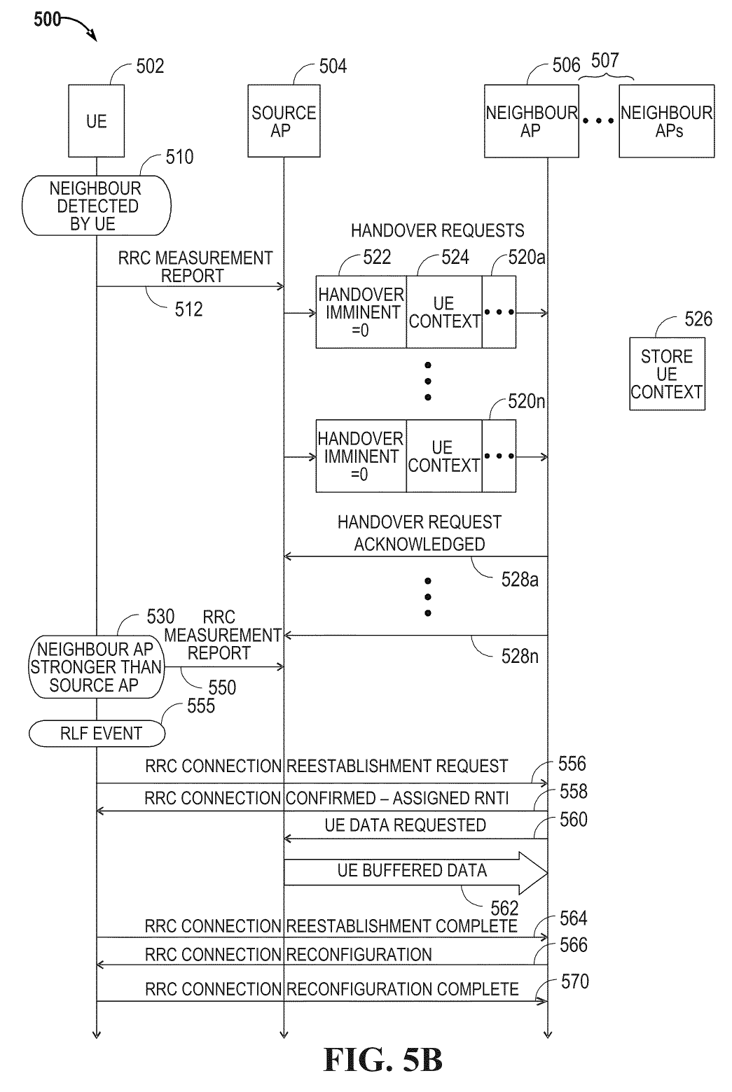

With reference to FIG. 5A, a methodology 500 of a wireless communication system is illustrated. In one embodiment, a source AP 504 may generate handover request messages 520A-520N for user equipment (UE) 502 if the UE detects at least one neighbour AP (circle 510). The handover request message may be sent to the neighbour AP detected by the UE, or to a set of neighbours known at the source AP 504 via configuration or awareness of prior handovers. A handover request message 520 may include a handover imminent flag 522. The handover request messages 520A-520N may be transmitted to the neighbour APs 507. If the handover imminent flags 522 indicate that a handover is not imminent, the neighbour APs 507 do not reserve radio network temporary identifiers (RNTIs) for the UE 502. The source AP 504 may set the flag to a ‘not imminent’ state if the signal strength of the neighbour AP is not strong enough to require handover.

In one embodiment, the neighbour APs 507 may store received UE context information 526 in which the UE context information 524 is included in the handover request messages 520A-520N. However, when a handover does become imminent (e.g. the UE reports that the signal strength of the neighbour AP is strong), a handover request message 540 may be transmitted to a receiving neighbour AP 506, in which the handover imminent flag 542 indicates that handover is imminent and the receiving neighbour AP 506 reserves a radio network temporary identifier (RNTI) for the UE 502 and may utilize the previously stored UE context information 526.

It should be appreciated, as previously described in detail with reference to FIG. 2, that the UE 250 and APs 210 include a processor (e.g. processors 270 and 230) and a memory (e.g. memory 272 and 232) to perform these functions as well as other functions to be hereinafter described. For example, in one embodiment, source AP 504 includes a memory to retain instructions for generating handover request messages 520A-520N for UE 502 based upon the UE detecting neighbour APs 507 in which the handover request messages 520A-520N include a handover imminent flag 522. Further, memory of the source AP 504 retains instructions for transmitting the handover request messages 520A-520N to the neighbour APs 507, wherein if the handover imminent flag 522 indicates that a handover is not imminent, the neighbour APs 507 do not reserve a radio network temporary identifier (RNTI) for the UE 502. A processor of the source AP 504 executes these instructions. Similarly, the previously-described processors and memories of the UE and APs may be utilized to execute instructions to perform the hereinafter described functions.

As shown in FIG. 5A, a methodology 500 for a wireless communication system is illustrated in which the source AP 504 generates handover request messages 520A-520N for user equipment (UE) 502 if the UE 502 detects at least one neighbour AP 507 (circle 510). The handover request message 520 includes a handover imminent flag 522.

In one embodiment, neighbour APs 507 are detected by the UE (circle 510) and a radio resource control (RRC) measurement report 512 is transmitted to the source AP 504. The RRC measurement report is a protocol measurement of neighbouring APs that is well known in the art. Based upon this, handover request messages 520A-520N are sent to the identified neighbouring APs 507. The handover request messages 520A-520N may each include a handover imminent flag 522, UE context information 524, along with other data. The UE context 524 typically includes security keys, quality of service (QoS) settings, along with other data.

If the handover imminent flag 524 indicates that a handover is not imminent then the neighbour APs 507 do not reserve radio network temporary identifiers (RNTIs) for the UE. However, the receiving neighbour APs 507 may store the UE context information 526. Further, the neighbour APs 507 send back handover request acknowledgments 528A-528N to the source AP 504.

In one embodiment, the handover imminent flag 522 may be a binary indicator to indicate that handover is imminent or not imminent. For example, if the flag is set to “0” then the receiving neighbour APs 507 are told that they do not have to reserve a RNTI, or other resources, for this UE 502. However, as will be described, if the handover imminent flag is set to “1” by the source AP 504 then a particular neighbour AP 506 is being told that handover is imminent and the particular neighbour AP 506 reserves a RNTI for the UE 502, as will be described.

Thus, in one embodiment, if the handover imminent flag 522 is set to “0” by the source AP 504, then the receiving neighbour APs 507 are told that they do not have to reserve a RNTI, or other resources, for this UE 502. The receiving neighbour APs 507 may simply acknowledge the receipt of the handover request messages 520A-520N by returning handover request acknowledged messages 528A-528N and may simply store the UE context 526. Further, the neighbour APs 507 may not reserve other resources, such as, backhaul bandwidth, radio bandwidth, hardware processing elements, etc.

Storing the UE context 526 is a low cost operation for the neighbour APs 507 and only utilizes minimal memory resources to store the information related to the UE context data (e.g., security keys, QoS settings). As will be described, if the UE 502 attempts to re-establish communication with a particular prepared neighbouring AP 506, then the prepared neighbouring AP 506 can use the stored UE context 526 to quickly verify the identity of the UE 502 (e.g., authentication), and to quickly bring the UE 502 into a connected state.

For example, if signal conditions change, and handover becomes imminent, a handover request message with a change from handover imminent=0 may soon be followed by another message with handover imminent=1 such that the target neighbour AP 506 may then respond to the second message by assigning an RNTI to the UE 502.

Continuing with reference to FIG. 5A, at circle 530, the signal strength for one of the neighbour APs 506 becomes stronger than the source AP 504 and a RRC measurement report 550 is transmitted to the source AP 504. At this point, a new handover request message 540 is transmitted to the targeted neighbour AP 506 that includes a handover imminent flag 542 set to indicate that handover is imminent (e.g., handover imminent=1). Also, additional UE context information 542, as well as user data, may also be transmitted. Based upon this, the neighbour AP 506 assigns an RNTI for the UE 502 and transmits a handover request acknowledged message 546 back to the source AP 504. The source AP 504 may then transmit a handover command 560 to the UE 502. It should be appreciated that the stored UE context 526 is used by the targeted neighbour AP 506 for the handover request to quickly verify the identity of the UE 502 and to quickly bring the UE 502 into a connected state.

The UE 502 transmits a reconfiguration complete message 564 to the source AP 504. Based upon these transmissions, the UE 502 has been handed over to the neighbour AP 506 such that the neighbour AP 506 aids the UE 502 in wireless communication.

Referring to FIG. 5B, FIG. 5B illustrates another scenario in which a radio link failure (RLF) event occurs. As in FIG. 5A, the UE 502 detects neighbour APs 507 (circle 510) and transmits a RRC measurement report 512 to source AP 504. Source AP 504 transmits handover request messages 520A-520N to the neighbour APs 507. Included in the handover request messages 520A-520N are the handover imminent flags 522 that are set to “0” and the UE context information 524 along with other data. The neighbour APs 507 store the UE context information 526 and further transmit back handover request acknowledged messages 528A-528N back to the source AP 504.

At circle 530, at which point the UE 502 finds a particular neighbour AP 506 that has a stronger signal source than the source AP 504, the UE 502 attempts to transmit a RRC measurement report 550. However, the transmission of the RRC measurement report 550 fails and an RLF event (circle555) occurs. After RLF, the UE 502 searches for a suitable AP to re-establish the connection, and transmits a RRC connection reestablishment request 556 to the targeted neighbour AP 506. In the message 556, the UE 502 includes its identity. Responsive to that, the neighbour

AP 506 recognizes that the identity is the same as the one received in the context as part of the handover request message 520A-520N. Upon recognizing this, the AP 506 assigns a RNTI to the UE 502 and transmits back a RRC connection confirmed 558 to the UE 502. The neighbour AP 506 then transmits a UE data request 560 to the source AP 504. In return, the source AP 504 transmits the requested UE buffer data 562 to the neighbour AP 506.

UE 502 then transmits a RRC connection reestablishment complete 564 back to the neighbour AP 506 and the neighbour AP 506 transmits a RRC connection reconfiguration 566 back to the UE 502. Lastly, the UE 502 transmits back a RRC connection reconfiguration complete message 570 back to the neighbour AP 506 indicating that UE 502 is configured for wireless communication through the neighbour AP 506. It should be appreciated that in this embodiment, as with the embodiment of FIG. 5A, the stored UE context 526 is used by the neighbour AP 506 to quickly verify the identity of the UE 502 and to quickly bring the UE 502 into a connected state. Further, it should be appreciated that the RNTI is allocated to the UE 502 only after the re-establishment procedure, and not at the time of handover request message 520, thereby reducing the overall usage of RNTIs.

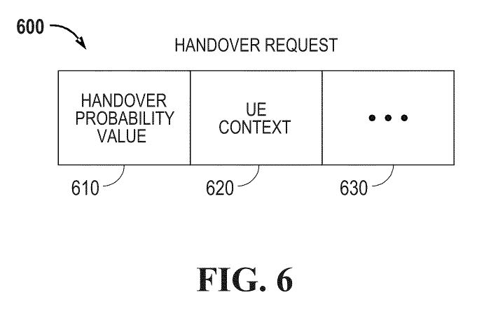

Referring briefly to FIG. 6, FIG. 6 is a block diagram showing a handover request message 600 with a handover probability value 610. In one embodiment, the handover imminent flag may be a handover probability value 610 which indicates the probability of whether handover is imminent or not imminent. As previously described with reference to FIG. 5, the handover imminent flag was a binary value that was used to indicate whether the handover was imminent or not imminent. In the binary data example, the handover imminent flag set to 0 meant that handover was not imminent whereas the handover imminent flag set to 1 meant that handover was imminent.

In one embodiment, the handover request message 600 includes a handover probability value 610, UE context information 620, along with other data 630. In this embodiment, the source AP 504 may set a probability value that indicates the likelihood that the UE 502 will be handed over to the neighbour APs 507. For example, a targeted neighbour AP 506 may use this probability value, in addition to its loading level along with other factors, to decide whether to assign an RNTI and allocate other resources to the UE 502. As resources are allocated, the information about the resources can be sent back to the source AP 504. If resources are not allocated, then only an acknowledgement may be sent back to the source AP 504.

Further, in one embodiment, if the signal conditions change and handover becomes less imminent, a handover cancel message may be sent from the source AP 504 to the targeted neighbour AP 506. This message may cause the targeted neighbour AP 506 to purge the UE context 526 from memory. Thus, if the handover changes become less imminent, then a handover cancel message may be sent to the neighbour AP 506 and the UE context 526 stored at the neighbour AP 506 may be erased. This may occur if either handover requests with handover imminent set to 0 are initially sent when neighbour APs 507 are detected and the neighbour APs 507 then become weaker than some predetermined criteria or if the handover request is actually transmitted with the handover imminent flag set to 1 and then the targeted neighbour AP 506 becomes weaker than the source AP 504. Further, this may similarly occur due to changes in the handover probability value.

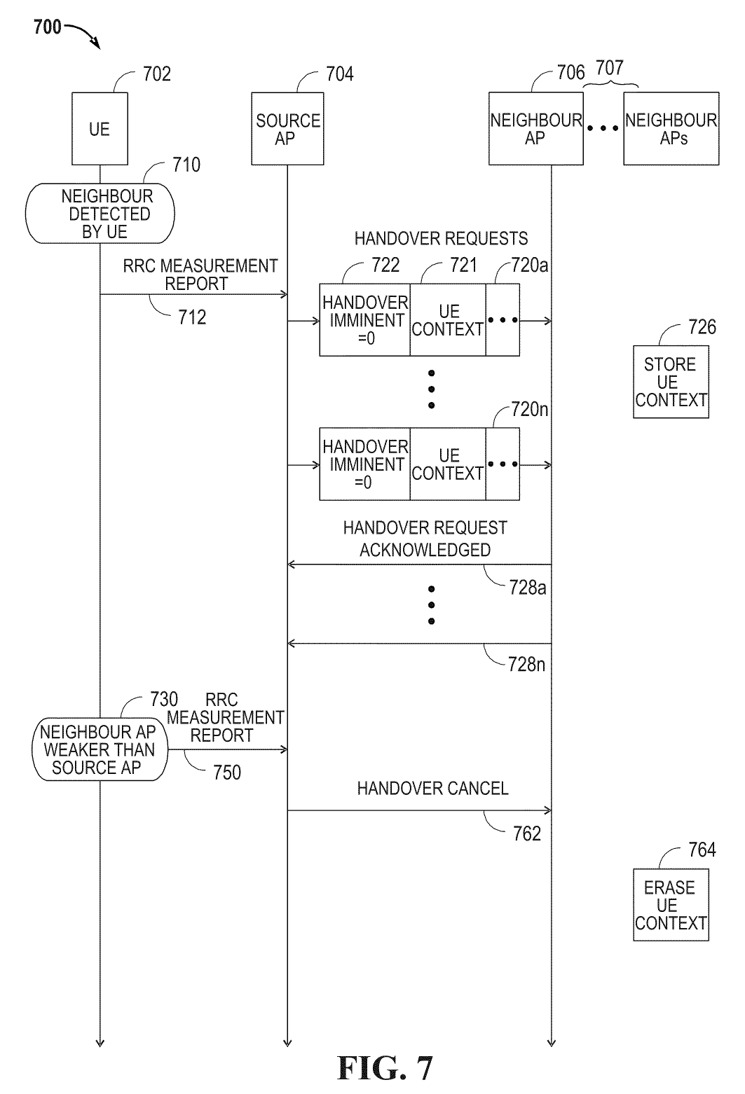

Referring to FIG. 7, FIG. 7 is an example of a methodology 700 for transmitting a handover cancel message to a neighbour AP. UE 702 detects neighbour APs 707 (circle 710) and transmits an RRC measurement report 712 to source AP 704. Source AP 704 transmits handover request messages 720A-720N. The handover request messages 720A-720N may each include a handover imminent flag 722, UE context 721, along with other data. In this example, the handover imminent flag 722 is set to 0. The neighbour APs 707 store the UE context 726. Further, the neighbour APs 707 send handover requests acknowledged messages 728A-728N back to source AP 704.

At circle 730, UE 702 then finds that the signals from the neighbour APs 707 have become weaker than some predetermined criteria (such as being weaker than the source AP 704). UE 702 may then transmit a RRC measurement report 750 to source AP 704. Source AP 704 may then transmit a handover cancel message 762 to the neighbour APs 707. The neighbour APs 707 may then erase the UE context (circle 764).

As previously described, if either handover request messages with handover imminent set to 0 are initially transmitted when neighbour APs 707 are detected and the signals from the neighbour APs 707 then become weaker than the source AP 704, or, if the handover request is transmitted with the handover imminent flag set to 1 and then the signals from the targeted neighbour AP 706 becomes weaker than the source AP 704, a handover cancel message 762 may be sent to the neighbour APs 707 and/or the targeted neighbour AP 706 and the UE context 764 stored at the neighbour APs 707 may be erased. This may similarly occur due to changes in the handover probability value.

In one embodiment, if the UE context changes (e.g., the security key or QoS configuration) for the UE, then the source AP may transmit a handover cancel message, followed by a new handover request message with the updated UE context. Further, to prevent loss of synchronization of the UE context across the prepared cell, the UE may transmit a signature/counter to the target cell during re-establishment, indicating the latest UE context, as will be described in more detail later.

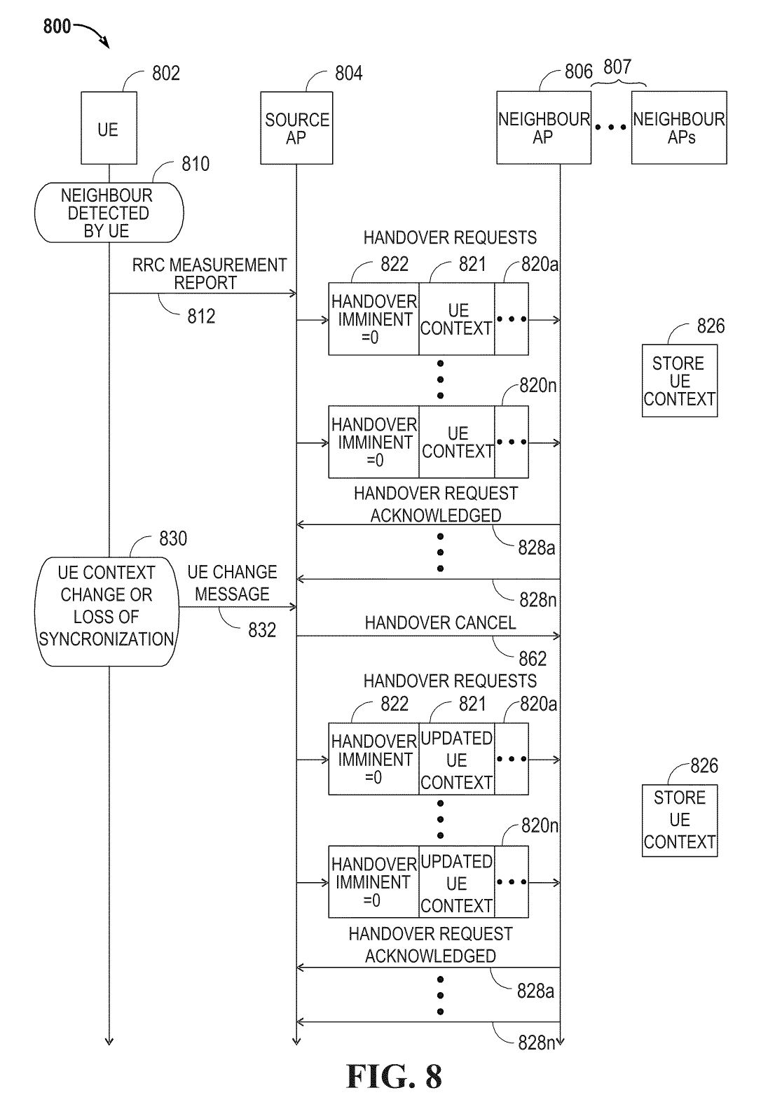

With reference to FIG. 8, FIG. 8 is an example of a methodology 800 for UE context change or loss of synchronization. UE 802 may detect neighbour APs (circle 810) and transmit an RRC measurement report message 812 to source AP 804. Source AP 804 may transmit a plurality of handover request messages 820A-820N including handover imminent flags set not being imminent 822, UE context information 821, along with other information, to the neighbour APs 807. Neighbour APs 807 may store the UE context information 826. Neighbour APs 807 may then transmit handover request acknowledged messages 828A-828N to the source AP 804.

However, at circle 830, UE 802 may have a UE context change or loss of synchronization, and will report this to source AP 804 via the transmission of UE change message 832. Source AP 804 may then transmit a handover cancel message 862 to the neighbour APs 807. It should be appreciated that the UE context change may be detected at either the UE 802 or the source AP 804. For example, if the UE context change is detected at the source AP 804 then the UE change message 832 is not needed.

Source AP 804 may then transmit new handover request messages 820A-820N that includes updated UE context 821 to the neighbour APs 807. Neighbour APs 807 may then store the updated UE context (stored UE context 826), transmit handover request acknowledged messages 828A-828N, and handover processing techniques may continue.

Therefore, in one embodiment, if the UE context changes (e.g., the security key or QoS configuration) for the UE 802, then the source AP 804 may transmit a handover cancel message 862, followed by new handover request messages 820A-820N with the updated UE context 821. Alternatively, an update message may be transmitted from the source AP 804 to the targeted neighbour AP 806, informing the targeted neighbour AP 806 of the change in UE context.

Further, loss of synchronization of the QoS state between the UE 802 and the neighbour APs 807 can cause unpredictable errors that may be difficult to trace or debug. In one embodiment, the UE 802 may transmit a signature/counter to the target neighbour AP 806 during re-establishment, indicating the latest UE context. As examples, the signature counter may be transmitted with the RRC connection reestablishment request message 556 or the RRC connection reestablishment complete message 564 (as shown in FIG. 5B). Thus, to prevent loss of synchronization of the UE context across the prepared cell, the UE 802 may transmit a signature/counter to the targeted neighbour AP 806 during re-establishment, indicating the latest UE context. If the targeted neighbour AP 806 has a different version of the context, the reestablishment may be rejected by the source AP 804 transmitting a handover cancel message 862 to the targeted neighbour AP 806.

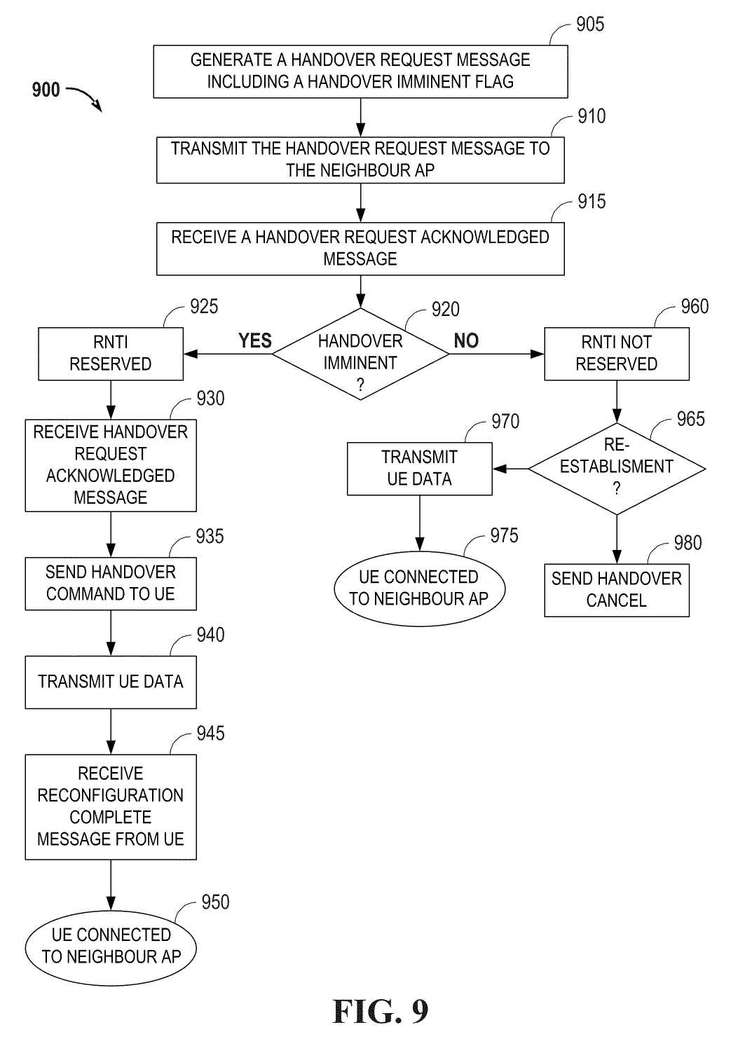

With reference to FIG. 9, FIG. 9 is a flowchart that illustrates functions 900 performed by the source AP to enable the previously-described methodology for handover robustness to neighbour APs. At block 905, the source AP generates a handover request message including a handover imminent flag. For example, the source AP may generate the handover request message for a UE if the UE detects at least one neighbour AP. The source AP transmits the handover request message to the neighbour AP (block 910). As previously described, if the handover imminent flag indicates that a handover is not imminent, the neighbour AP does not reserve a radio network temporary identifier (RNTI) for the UE. The source AP may set the flag to a ‘not imminent’ state if the signal strength of the neighbour AP is not strong enough to require handover. At block 915, the source AP receives a handover request acknowledged message from the neighbour AP.

At decision block 920, process 900 determines whether handover is imminent. If handover is imminent, (e.g. the UE reports that the signal strength of the neighbour AP is strong), a handover request message is transmitted by the source node to a receiving neighbour AP, in which the handover imminent flag indicates that handover is imminent (e.g., handover imminent=1) and the receiving neighbour AP reserves a radio network temporary identifier (RNTI) for the UE and may utilize the previously stored UE context information (block 925) (e.g. FIG. 5A). The source AP receives a handover request acknowledged message from the neighbour AP (block 930), sends a handover command to the UE (block 935), and transmits UE data to the neighbour AP (block 940). It should be appreciated that the stored UE context may be used by the targeted neighbour AP for the handover request to quickly verify the identity of the UE and to quickly bring the UE into a connected state. The source AP receives a reconfiguration complete message from the UE (block 945) and the UE is thereby connected to the neighbour AP (circle 950).

On the other hand, if process 900 determines that handover is not imminent (decision block 920), then other process functions may occur. For example, if handover is not imminent, a RNTI is not reserved (block 960). Further, process 900 may determine whether the UE is attempting reestablishment with a neighbour AP (decision block 965). If so, the source node transmits UE data to the neighbour AP based upon the UE attempting reestablishment with the neighbour AP (block 970). As previously described with reference to FIG. 5B, after a neighbour's AP signals become stronger than the source AP and an RLF event occurs, through various communications between the UE and the source and neighbour APs, the neighbour AP may assign an RNTI to the UE and the source AP may transmits requested UE data to the neighbour AP, and the UE may be connected to the neighbour AP (circle 975).

However, if handover is not imminent and reestablishment is not occurring, then the source AP may transmit a handover cancel message (block 980). For example, as described with reference to FIG. 7, the handover cancel message may be sent from the source AP to the neighbour AP due to the signal strength from the neighbour AP becoming weaker than the signal strength from the source AP. Moreover, as discussed with reference to FIG. 8, if the UE context changes (e.g., the security key or QoS configuration) for the UE, then the source AP may send a handover cancel message (block 980), followed by a new handover request message with updated UE context. However, it should be appreciated that with the new handover request message with updated UE context, the handover process may be re-engaged such that the UE is later connected to the neighbour AP.

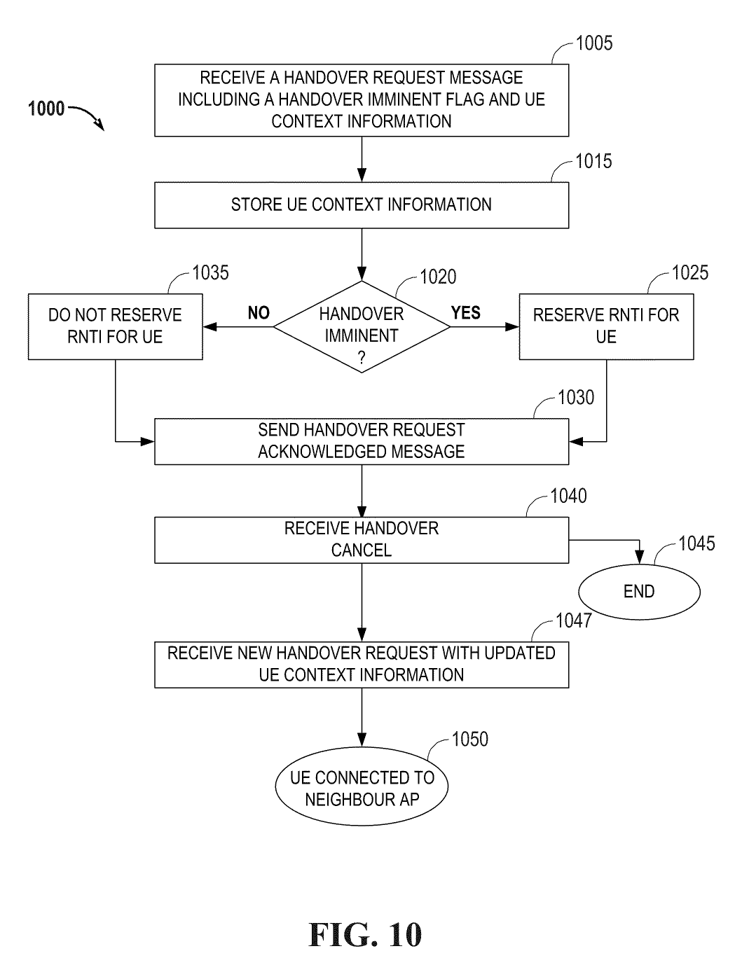

With further reference to FIG. 10, FIG. 10 is a flowchart that illustrates functions 1000 performed by the neighbour AP to enable the previously-described methodology for handover robustness. It should be appreciated that because the overall UE, source AP, and neighbour AP system interactions have been previously-described in detail, for brevities sake, only particular functions related to the neighbour AP are hereinafter described.

At block 1005, the neighbour AP receives a handover request message including a handover imminent flag and UE context information. The neighbour AP stores the UE context information (block 1015). Next, the neighbour AP determines if handover is imminent based upon the setting of the handover imminent flag set by the source AP (decision block 1020). If the handover imminent flag indicates that a handover is not imminent, the neighbour AP does not reserve a radio network temporary identifier (RNTI) for the UE (block 1035). As previously described, the source AP may set the flag to a ‘not imminent’ state if the signal strength of the neighbour AP is not strong enough to require handover. At block 1030, the neighbour AP sends a handover request acknowledged message to the source AP.

Conversely, at decision block 1020, if the neighbour AP determines that handover is imminent based upon the handover imminent flag setting from the source AP (e.g., handover imminent=1), then the receiving neighbour AP reserves a radio network temporary identifier (RNTI) for the UE and may utilize the previously stored UE context information (block 1025) (e.g. FIG. 5A). At block 1030, the neighbour AP sends a handover request acknowledged message to the source AP.

As previously described, with reference to FIG. 5A, the source AP may receive the handover request acknowledged message from the neighbour AP, transmit a handover command to the UE, transmit UE data to the neighbour AP, receive a reconfiguration complete message from the UE, and the UE is thereby connected to the neighbour. Alternatively, as previously described with reference to FIG. 5B, if handover is not imminent, a RNTI is not reserved, and after a neighbour's AP signals become stronger than the source AP and an RLF event occurs, through various communications between the UE and the source and the neighbour APs, the neighbour AP may assign an RNTI to the UE and the source AP may transmit requested UE data to the neighbour AP, and the UE may be connected to the neighbour AP.

However, if handover is not imminent and reestablishment is not occurring, then the neighbour AP may receive a handover cancel message from the source AP (block 1040) and process 1000 ends (block 1045). For example, as described with reference to FIG. 7, the handover cancel message may be sent from the source AP to the neighbour AP due to the signal strength from the neighbour AP becoming weaker than the signal strength from the source AP. On the other hand, as discussed with reference to FIG. 8, if the UE context changes (e.g., the security key or QoS configuration) for the UE, then a handover cancel message may received by the neighbour AP (block 1040), a new handover request message with updated UE context may then be received by the neighbour AP (1047), and the handover process may be re-engaged such that the UE is later connected to the neighbour AP (block 1050).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A wireless communications method, comprising:
generating a handover request message at a source base station (BS) for a user equipment (UE), if the UE detects at least one neighbour BS, the handover request message including a handover imminent flag; and
transmitting the handover request message to the neighbour BS, wherein if the handover imminent flag indicates that a handover is not imminent, the neighbour BS does not reserve a radio network temporary identifier (RNTI) for the UE.

2. The method of claim 1, further comprising:
storing UE context information at the neighbour BS; and
transmitting a handover request acknowledgement to the source BS.

3. The method of claim 2, wherein if handover becomes imminent, further comprising:
transmitting the handover request message to the neighbour BS, wherein the handover imminent flag indicates that handover is imminent; and
reserving a radio network temporary identifier (RNTI) for the UE at the neighbour BS.

4. The method of claim 2, further comprising:
requesting the source BS to transmit UE data based upon the UE attempting reestablishment with the neighbour BS; and
transmitting UE data to the neighbour BS.

5. The method of claim 2, further comprising using the stored UE context information for the handover request.

6. The method of claim 2, wherein if the handover changes back to a not imminent status, further comprising:
transmitting a handover cancel message to the neighbour BS; and
erasing the UE context stored at the neighbour BS.

7. The method of claim 6, wherein the handover cancel message is sent to the neighbor BS due to signal strength from the neighbor BS becoming weaker than the signal strength from the source BS to the UE.

8. The method of claim 2, wherein if a UE context change occurs, further comprising:
transmitting a handover cancel message to the neighbour BS; and
transmitting a new handover request with updated UE context data.

9. The method of claim 2, further comprising including a signature counter with the handover request message, wherein if the signature counter of the handover request message does not match the signature counter associated with the UE at the neighbour BS, a handover cancel message is transmitted to the neighbour BS.

10. The method of claim 1, wherein the handover imminent flag is a binary indicator to indicate that handover is imminent or not imminent.

11. The method of claim 1, wherein the handover imminent flag is a probability value indicating the probability of whether handover is imminent or not imminent.

12. The method of claim 11, further comprising reserving a radio network temporary identifier (RNTI) for the UE at the neighbour BS based upon the probability value and a loading level.

13. The method of claim 1, further comprising the neighbour BS not reserving at least one of backhaul bandwidth, radio bandwidth, and hardware processing elements.

14. A communications apparatus, comprising:
a memory storing instructions; and
a processor coupled to the memory to execute the instructions and further configured to generate a handover request message for a user equipment (UE) based upon the UE detecting at least one neighbour base station (BS), the handover request message including a handover imminent flag, and to transmit the handover request message to the neighbour BS, wherein if the handover imminent flag indicates that a handover is not imminent, the neighbour BS does not reserve a radio network temporary identifier (RNTI) for the UE.

15. The communications apparatus of claim 14, wherein the neighbour BS stores UE context information at the neighbour BS and transmits a handover request acknowledgement to the communications apparatus.

16. The communications apparatus of claim 15, wherein if handover becomes imminent, the processor is further configured to transmit the handover request message to the neighbour BS with the handover imminent flag indicating that handover is imminent, wherein the neighbour BS reserves a radio network temporary identifier (RNTI) for the UE.

17. The communications apparatus of claim 15, wherein the processor is further configured to transmit UE data to the neighbour BS based upon the UE attempting reestablishment with the neighbour BS.

18. The communications apparatus of claim 15, wherein the neighbour BS uses the stored UE context information for the handover request.

19. The communications apparatus of claim 15, wherein if the handover changes back to not imminent, the processor is further configured to transmit a handover cancel message to the neighbour BS, wherein the neighbour BS erases the UE context stored at the neighbour BS.

20. The communications apparatus of claim 19, wherein the handover cancel message is sent to the neighbor BS due to signal strength from the neighbor BS becoming weaker than the signal strength from the source BS to the UE.

21. The communications apparatus of claim 15, wherein if a UE context change occurs, the processor is further configured to:
transmit a handover cancel message to the neighbour BS; and
transmit a new handover request with updated UE context data.

22. The communications apparatus of claim 15, wherein the processor is further configured to include a signature counter with the handover request message.

23. The communications apparatus of claim 14, wherein the handover imminent flag is a binary indicator to indicate that handover is imminent or not imminent.

24. The communications apparatus of claim 14, wherein the handover imminent flag is a probability value indicating the probability of whether handover is imminent or not imminent.

25. The communications apparatus of claim 24, wherein the neighbour BS reserves a radio network temporary identifier (RNTI) for the UE based upon the probability value and a loading level.

26. The communications apparatus of claim 14, wherein the neighbour BS does not reserve at least one of backhaul bandwidth, radio bandwidth, and hardware processing elements.

27. An apparatus operable in a wireless communication system, the apparatus comprising:
means for generating a handover request message at a source base station (BS) for a user equipment (UE), if the UE detects at least one neighbour BS, the handover request message including a handover imminent flag; and
means for transmitting the handover request message to the neighbour BS, wherein if the handover imminent flag indicates that a handover is not imminent, the neighbour BS does not reserve a radio network temporary identifier (RNTI) for the UE.

28. The apparatus of claim 27, further comprising:
means for storing UE context information at the neighbour BS; and
means for transmitting a handover request acknowledgement to the source BS.

29. The apparatus of claim 28, wherein if handover becomes imminent, further comprising:
means for transmitting the handover request message to the neighbour BS, wherein the handover imminent flag indicates that handover is imminent; and
means for reserving a radio network temporary identifier (RNTI) for the UE at the neighbour BS.

30. The apparatus of claim 26, further comprising:
means for requesting the source BS transmit UE data based upon the UE attempting reestablishment with the neighbour BS; and
means for transmitting UE data to the neighbour BS.

31. The apparatus of claim 26, further comprising means for using the stored UE context information in the handover request.

32. The apparatus of claim 28, wherein if the handover changes back to not imminent, further comprising:
means for transmitting a handover cancel message to the neighbour BS; and
means for erasing the UE context stored at the neighbour BS.

33. The apparatus of claim 32, wherein the handover cancel message is sent to the neighbor BS due to signal strength from the neighbor BS becoming weaker than the signal strength from the source BS to the UE.

34. The apparatus of claim 28, wherein if a UE context change occurs, further comprising:
means for transmitting a handover cancel message to the neighbour BS; and
means for transmitting a new handover request with updated UE context data.

35. The apparatus of claim 28, further comprising means for including a signature counter within the handover request message, wherein if the signature counter of the handover request message does not match the signature counter associated with the UE at the neighbour BS, a handover cancel message is transmitted to the neighbour BS.

36. The apparatus of claim 27, wherein the handover imminent flag is a binary indicator to indicate that handover is imminent or not imminent.

37. The apparatus of claim 27, wherein the handover imminent flag is a probability value indicating the probability of whether handover is imminent or not imminent.

38. The apparatus of claim 27, wherein the neighbour BS does not reserve at least one of backhaul bandwidth, radio bandwidth and hardware processing elements.

39. A computer program product, comprising:
a computer-readable medium further comprising code for causing at least one computer to:
generate a handover request message at a source base station (BS) for a user equipment (UE), if the UE detects at least one neighbour BS, the handover request message including a handover imminent flag; and
transmit the handover request message to the neighbour BS, wherein if the handover imminent flag indicates that a handover is not imminent, the neighbour BS does not reserve a radio network temporary identifier (RNTI) for the UE.

40. The computer program product of claim 39, further comprising code for causing at least one computer to:
store UE context information at the neighbour BS; and
transmit a handover request acknowledgement to the source BS.

41. The computer program product of claim 40, wherein if handover becomes imminent, further comprising code for causing at least one computer to:
transmit the handover request message to the neighbour BS, wherein the handover imminent flag indicates that handover is imminent; and
reserve a radio network temporary identifier (RNTI) for the UE at the neighbour BS.

42. The computer program product of claim 40, further comprising code for causing at least one computer to:
request the source BS transmit UE data based upon the UE attempting reestablishment with the neighbour BS; and
transmit UE data to the neighbour BS.

43. The computer program product of claim 40, further comprising code for causing at least one computer to use the stored UE context information for the handover request.

44. The computer program product of claim 40, wherein if the handover changes back to not imminent, further comprising code for causing at least one computer to:
transmit a handover cancel message to the neighbour BS; and
erase the UE context stored at the neighbour BS.

45. The computer program product of claim 44, wherein the handover cancel message is sent to the neighbor BS due to signal strength from the neighbor BS becoming weaker than the signal strength from the source BS to the UE.

46. The computer program product of claim 40, wherein if a UE context change occurs, further comprising code for causing at least one computer to:
transmit a handover cancel message to the neighbour BS; and
transmit a new handover request with updated UE context data.

47. The computer program product of claim 40, further comprising code for causing at least one computer to include a signature counter with the handover request message, wherein if the signature counter of the handover request message does not match the signature counter associated with the UE at the neighbour BS, a handover cancel message is transmitted to the neighbour BS.

48. The computer program product of claim 39, wherein the handover imminent flag is a binary indicator to indicate that handover is imminent or not imminent.

49. The computer program product of claim 39, wherein the handover imminent flag is a probability value indicating the probability of whether handover is imminent or not imminent.

50. The computer program product of claim 49, further comprising code for causing at least one computer to reserve a radio network temporary identifier (RNTI) for the UE at the neighbour BS based upon the probability value and a loading level.
